(19) United States
(12) Patent Application Publication
(10) Pub. No.: US 2011/0134011 A1
(43) Pub. Date: Jun. 9, 2011

(54) ANTENNA APPARATUS AND WIRELESS COMMUNICATION APPARATUS

(75) Inventor: Takashi Yamagajo, Kawasaki (JP)

(73) Assignee: FUJITSU LIMITED, Kawasaki-shi (JP)

(21) Appl. No.: 12/940,386

(22) Filed: Nov. 5, 2010

(30) Foreign Application Priority Data
Dec. 4, 2009 (JP) 2009-276696

(51) Int. Cl. H01Q 1/50

(52) U.S. Cl. 343/860

(57) ABSTRACT

An antenna apparatus includes an antenna linear element including a linear conductor provided with a first end and a second end, a ground conductor connected to the linear conductor at the second end, a transmission line connected to the linear conductor at the first end, and a matching circuit including a first impedance adjustment element connected to the transmission line at an end on an opposite side to the end of transmission line connected to the linear conductor and a second impedance adjustment element which is connected to the first impedance adjustment element on an opposite side to the end of the first impedance adjustment element connected to the transmission line and an end of which on an opposite side to the end connected to the first impedance adjustment element is grounded, a connection part between the first impedance adjustment element and second impedance adjustment element receiving a power feed.

### CROSS-REFERENCE TO RELATED APPLICATIONS

This application is based upon and claims the benefit of priority of the prior Japanese Patent Application No. 2009-276696, filed on Dec. 4, 2009, the entire contents of which are incorporated herein by reference.

### FIELD

Embodiments herein relates to an antenna apparatus provided with a matching circuit and a wireless communication apparatus.

### BACKGROUND

These days, mobile terminal apparatuses carry out transmission and reception by using a plurality of wireless frequencies. For example, for a frequency band for IMT2000, an 800 MHz band, a 1.7 GHz band, and a 2 GHz band are allocated, and a wireless frequency in these frequency bands is used. Also, in Super 3G that is expected to be in practical use, the above-mentioned frequency bands are used.

An antenna used in the mobile terminal apparatus employing these various wireless frequencies as a use frequency is used by combining monopole antennas or dipole antennas having a simple configuration using a linear element. In the monopole antenna, in a case where a set use frequency is equal to or smaller than 1 GHz, it is difficult to realize an impedance matching with a simple structure.

Also, in order to enhance a radiation efficiency of the antenna, a radiation resistance (impedance) of the antenna is increased. The radiation resistance of the dipole antenna is approximately 73Ω, and the radiation resistance of the monopole antenna is approximately 36Ω. Therefore, the dipole antenna is superior to the monopole antenna in terms of the radiation efficiency.

Incidentally, among antenna elements provided with a single linear conductor, a folded monopole antenna is proposed which has a folded shape whose extending direction is changed by 180 degrees in mid-course while power is fed to one end and the other end is grounded. One end of this folded monopole antenna is grounded. The folded monopole antenna functions like a folded dipole antenna and has a higher radiation resistance as compared with the monopole antenna. Thus, the radiation efficiency as an antenna is high. Furthermore, as compared with the folded dipole antenna, the folded monopole antenna has a simpler configuration and is therefore easy to be built in a small-sized wireless communication apparatus such as a mobile terminal apparatus.

A wireless apparatus using the folded monopole antenna with such characteristics is proposed. The wireless apparatus is an apparatus having a simple shape antenna capable of realizing multiple resonances and impedance matching. In the folded monopole antenna used in this wireless apparatus, a starting end is connected to a feeding point for the power feed, and a length between the starting end and a terminal end is equivalent to a ½ wavelength of a first frequency belonging to the use frequency band.

### SUMMARY

On the other hand, with regard to the antenna for the mobile terminal apparatus, a design method for an antenna apparatus in which the frequency for impedance matching can be changed is proposed. According to this design method, the following matching circuit is provided between the antenna element and a power feed circuit. The matching circuit is provided with a first inductance element and a capacitance element directly connected to the antenna element, and a second inductance element connected in parallel to this antenna element, the first inductance element, and the capacitance element. In this antenna apparatus, by adjusting the capacitance element, the frequency for impedance matching can variously be changed.

According to an aspect of the embodiment, an antenna apparatus includes an antenna linear element including a linear conductor provided with a first end and a second end, a ground conductor connected to the linear conductor at the second end, a transmission line connected to the linear conductor at the first end, and a matching circuit including a first impedance adjustment element connected to the transmission line at an end on an opposite side to the end of the transmission line connected to the linear conductor and a second impedance adjustment element which is connected to the first impedance adjustment element at an end on an opposite side to the end of the first impedance adjustment element connected to the transmission line and an end of which on an opposite side to the end connected to the first impedance adjustment element is grounded, a connection part between the first impedance adjustment element and the second impedance adjustment element receiving power feed.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1A is a block configuration diagram for an outline of a wireless communication apparatus according to a first embodiment;

FIG. 1B schematically shows a configuration of a matching circuit used in the wireless communication apparatus shown in FIG. 1A;

FIG. 1C shows an example of a matching circuit different from the matching circuit shown in FIG. 1B;

FIGS. 2A, 2B, and 2C are explanatory diagrams for describing an impedance matching carried out in the matching circuit shown in FIG. 1B or FIG. 1C;

FIG. 3 shows an area where the impedance matching can be carried out in the matching circuit shown in FIG. 1B;

FIG. 4 shows a schematic configuration of a wireless communication apparatus according to a second embodiment;

FIG. 5A shows a schematic configuration of an antenna apparatus used in the wireless communication apparatus shown in FIG. 4;

FIG. 5B shows a matching circuit used in the wireless communication apparatus shown in FIG. 5A;

FIG. 6A is an arrow sectional view as taken along the a-a′ line in FIG. 5A;

FIG. 6B is an arrow sectional view as taken along the b-b′ line in FIG. 5B;

FIG. 7 shows dimension positions for respective parts in the antenna apparatus shown in FIG. 5A;

FIG. 8A shows an example of a calculation result based on an impedance simulation when an antenna linear element and a transmission line shown in FIG. 5A are viewed as a signal load circuit;

FIG. 8B shows an example of a frequency dependency of a reflection coefficient calculated by using the impedance calculation result shown in FIG. 8A;

FIG. 9 is a cross sectional view for describing another example of a transmission line different from the transmission line of the antenna apparatus shown in FIG. 5A;

FIG. 10A shows a schematic configuration of an antenna apparatus according to a third embodiment;

FIG. 10B is an arrow sectional view as taken along the c-c′ line in FIG. 10A;

FIG. 11 shows dimension positions for respective parts in the antenna apparatus shown in FIG. 10A;

FIG. 12A shows an example of a calculation result based on an impedance simulation when an antenna linear element and a transmission line shown in FIG. 10A are viewed as a signal load circuit;

FIG. 12B shows an example of a frequency dependency of a reflection coefficient calculated by using the impedance calculation result shown in FIG. 12A;

FIG. 13A and FIG. 13B each show examples of a shape of an antenna linear shape and an impedance locus when a line width W₂ shown in FIG. 7 is changed; and

FIG. 14A and FIG. 14B each show other examples of a shape of an antenna linear shape and an impedance locus when the line width W₂ shown in FIG. 7 is changed.

### DESCRIPTION OF EMBODIMENTS

In the above-mentioned wireless apparatus in related art, the folded monopole antenna is used, but an electric length between the starting end and the terminating end of this antenna is fixed to be equivalent to the ½ wavelength of the first frequency belonging to the use frequency band. For this reason, the multiple resonances cannot be realized by only using the folded monopole antenna where the above-mentioned length is constant. In the wireless apparatus in related art, in addition to the folded monopole antenna, by adding the monopole antenna, the multiple resonances are realized. On the other hand, in a case where the above-mentioned design method for the antenna apparatus is used, an imaginary part (reactance component) of the impedance of the antenna element is at least restricted to be negative. For this reason, in the folded monopole antenna, the frequency for impedance matching cannot freely be changed in some cases. Also in an antenna linear element in related art other than the folded monopole antenna, the electric length between the starting end and the terminating end of the antenna is a length corresponding to a predetermined frequency in the use frequency band, and therefore the frequency for impedance matching cannot freely be changed in some cases.

In view of the above, in order to solve the above-mentioned problems in the related art technology, and it is an object to provide an antenna apparatus provided with an antenna linear element capable of carrying out an impedance matching in accordance with a desired use frequency and a wireless communication apparatus.

A first aspect to achieve the above-mentioned object relates to an antenna apparatus provided with a matching circuit.

That is, the antenna apparatus includes:

(1) an antenna linear element including a linear conductor provided with a first end and a second end;

(2) a ground conductor connected to the linear conductor at the second end;

(3) a transmission line connected to the linear conductor at the first end; and

(4) a matching circuit including a first impedance adjustment element connected to the transmission line at an end on an opposite side to the end of the transmission line connected to the linear conductor and a second impedance adjustment element which is connected to the first impedance adjustment element at an end on an opposite side to the end of the first impedance adjustment element connected to the transmission line and an end of which on an opposite side to the end connected to the first impedance adjustment element is grounded, a connection part between the first impedance adjustment element and the second impedance adjustment element receiving power feed.

A second aspect to achieve the above-mentioned object relates to a wireless communication apparatus, including:

(5) the antenna apparatus;

(6) a transmission/reception circuit connected to the antenna apparatus; and

(7) a signal processing circuit connected to the transmission/reception circuit and configured to process a signal to be transmitted or a received signal.

The above-mentioned antenna apparatus and wireless communication apparatus can carry out the impedance matching in accordance with a desired use frequency.

Hereinafter, an antenna apparatus and a wireless communication apparatus according to the present invention will be described in detail on the basis of embodiments.

### First Embodiment

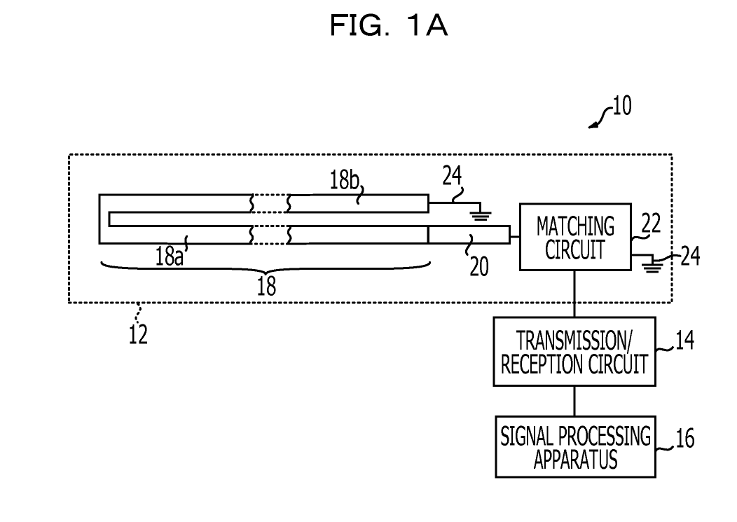

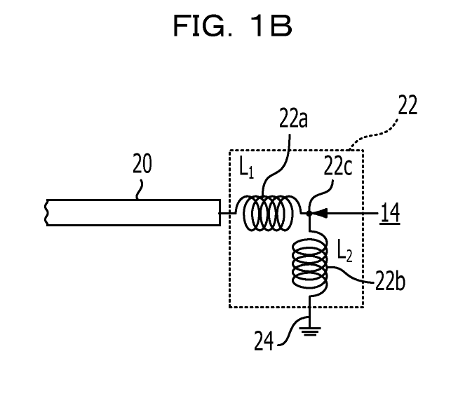

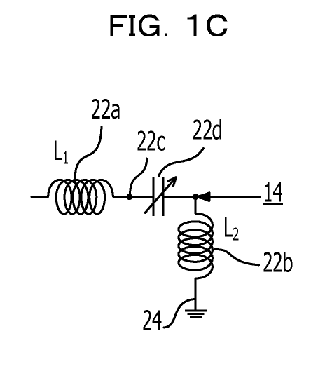

FIG. 1A is a schematic block configuration diagram of a wireless communication apparatus 10 according to a first embodiment. The wireless communication apparatus 10 is provided with an antenna apparatus 12, a transmission/reception circuit 14, and a signal processing circuit 16.

The antenna apparatus 12 is an apparatus capable of changing a frequency for impedance matching. The antenna apparatus 12 has an antenna linear element 18, a transmission line 20, a matching circuit 22, and a ground conductor 24.

The signal processing circuit 16 processes a signal to be transmitted or processes a received signal. The transmission/reception circuit 14 performs a modulation on the signal to be transmitted to generate a high frequency signal and feeds this high frequency signal to the antenna apparatus 12. Alternatively, the transmission/reception circuit 14 performs a demodulation on the received signal to be sent to the signal processing circuit 16.

The antenna linear element 18 of the antenna apparatus 12 is provided with a single linear conductor. This linear conductor has a shape whose extending direction is inverted in mid-course to be folded into a U-letter shape. That is, the antenna linear element 18 has an outward linear element 18a extending from a first end of the linear conductor up to the inverted position where the extending direction is inverted and an inward linear element 18b extending from the inverted position where the extending direction is inverted up to a second end of the linear conductor in parallel with the outward linear element 18a. The outward linear element 18a and the inward linear element 18b are connected to each other at the above-mentioned inverted position. The outward linear element 18a and the inward linear element 18b of the antenna linear element 18 each have a straight line shape, but the outward linear element 18a and the inward linear element 18b may be bent in mid-course while maintaining the parallel relation as in a second embodiment or a third embodiment which will be described below. It should be noted that the antenna linear element 18 according to the first embodiment uses a so-called folded monopole antenna, but other than this, the folded dipole antenna in related art or an antenna liner element having another shape may also be used. In particular, the folded monopole antenna like the antenna linear element 18 has a high degree of freedom in shape and is preferable because it is easy to adjust the impedance by adjusting the shape.

The line width of the inward linear element 18b is preferably wider than the line width of the outward linear element 18a. With this configuration, as will be described below, it is possible to suppress a change in a real part of the impedance on Smith chart.

The transmission line 20 functions as a distributed constant circuit which is connected to the end of the outward linear element 18a and which connects the matching circuit 22 with the outward linear element 18a. For the transmission line 20, for example, a coaxial cable is used in addition to a planar line provided on a dielectric substrate such as a microstrip line, a coplanar line, a strip line, or a slot line. In order to function as the distributed constant circuit, the transmission line 20 is composed of a line longer than a length of 1/100 of the wavelength corresponding to the use frequency used for the transmission or reception in the antenna apparatus 12.

The matching circuit 22 is a circuit for carrying out the impedance matching with respect to the antenna linear element 18 and the transmission line 20 so that the frequency for impedance matching can be changed. The matching circuit 22 is provided with two inductance elements as impedance adjustment elements. FIG. 1B shows a configuration of the matching circuit 22. The matching circuit 22 is provided with a first inductance element 22a (inductance value L₁) and a second inductance element 22b (inductance value L₂). The first inductance element 22a is directly connected to the transmission line 20 at an end on an opposite side to an end of the transmission line 20 connected to the outward linear element 18a. The second inductance element 22b is connected to the first inductance element 22a at an end 22c on an opposite side to the end of the first inductance element 22a connected to the transmission line 20. Furthermore, in the second inductance element 22b, an end on the opposite side to the end connected to the first inductance element 22a is connected to the ground conductor 24 and grounded. In other words, the second inductance element 22b is connected in parallel to the first inductance element 22a, the transmission line 20, and the antenna linear element 18.

It should be noted that the connection between the transmission/reception circuit 14 and the matching circuit 22 is established at a connection part between the first inductance element 22a and the second inductance element 22b. That is, this connection part functions as the feeding point.

The first inductance element 22a is an inductance variable element provided to change the reactance component of the impedance of the antenna apparatus 12. According to the first embodiment, the inductance variable element is used as the first inductance element 22a for changing the reactance component of the impedance of the antenna apparatus 12, but in addition to the inductance variable element, as shown in FIG. 1C, a variable capacitor 22d may be used by being connected in series to the first inductance element 22a. In this case, the end of the first inductance element 22a is connected to the second inductance element 22b via the variable capacitor 22d. Also, the variable capacitor 22d may be provided between the first inductance element 22a and the transmission line 20. In this case, the end of the first inductance element 22a is connected to the transmission line 20 via the variable capacitor 22d.

The variable capacitor 22d can accurately and widely adjust the reactance component of the impedance of the antenna apparatus 12 through the adjustment on the capacitance. Therefore, in a case where the variable capacitor 22d is used, an inductance fixed element may also be used as the first inductance element 22a.

Also, the matching circuit 22 is provided with the first inductance element 22a and the second inductance element 22b as the impedance adjustment elements, but instead of the first inductance element 22a and the second inductance element 22b, the first capacitance element and the second capacitance element can also be used at the same arrangement locations.

For the variable capacitor 22d, for example, a varactor diode, which has a wide variable capacitance and can control the capacity by a voltage, is used. Alternatively, as the variable capacitor 22d, an MEMS variable capacitor fabricated on the basis of MEMS (Micro Electro Mechanical Systems) may be used.

The MEMS variable capacitor is, for example, an element in which an elongated lower variable electrode and an elongated upper variable electrode are arranged while being mutually intersected with a narrow gap on a substrate and a capacitor is formed in the intersection area. A dielectric layer having a high dielectric constant is provided on a surface of the lower variable electrode on the upper variable electrode. The lower variable electrode is bent towards the upper variable electrode upon voltage application, and a part comes close to the upper variable electrode. With this configuration, the capacity is changed, and a high Q value is provided in addition to the wide variable capacity.

The ground conductor 24 is a grounded conductor. In a case, for example, where the antenna linear element 18 is provided on the dielectric substrate, the ground conductor 24 is provided on this dielectric substrate as a conductive film. For the conductive film, a conductive metallic film such as copper, silver, gold, or platinum is used.

Thus far, the configuration of the wireless communication apparatus 10 has been described.

It should be noted that a range on the use frequency for the transmission or reception which is used in the antenna apparatus 12 is set in advance, and in accordance with this range of the use frequency, the shape dimensions of the antenna linear element 18 and the transmission line 20 and the inductance of the matching circuit 22 are set. The electric length between the outward linear element 18a and the inward linear element 18b becomes equal to a length of ¼ of the wavelength corresponding to a predetermined frequency within this range of the use frequency for resonance. In the folded monopole antenna, an impedance at a resonance frequency is larger than 50Ω, and within the range of the use frequency used by the antenna apparatus 12, the antenna linear element 18 alone does not have the impedance matching. However, by using the transmission line 20 and adjusting the matching circuit 22, the antenna apparatus 12 has the impedance matching at the use frequency.

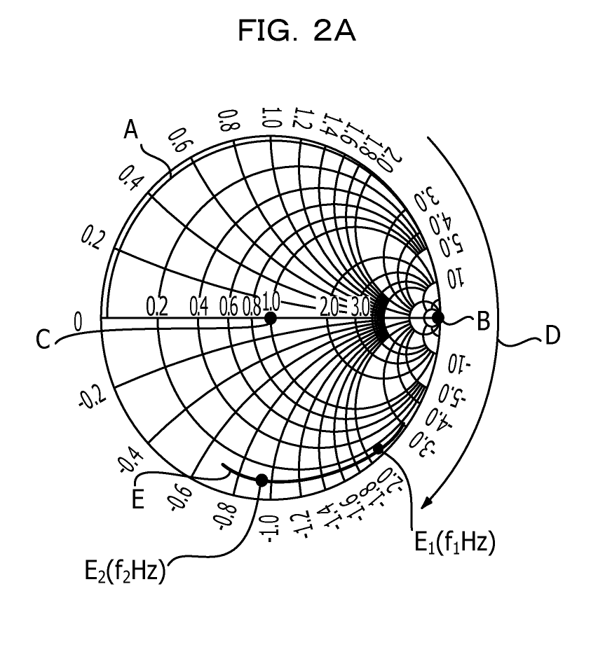

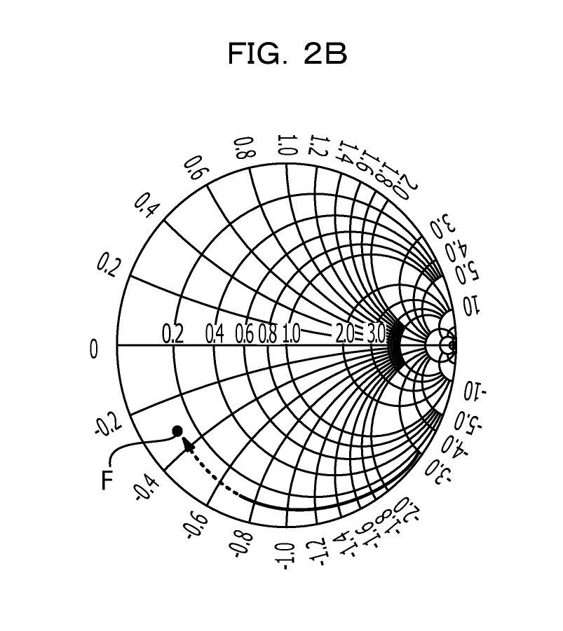

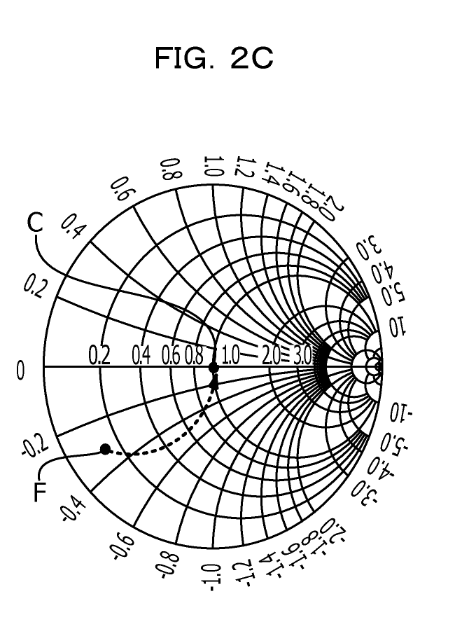

Next, the impedance matching in the antenna apparatus 12 will be described by using the Smith chart. FIG. 2A to FIG. 2C are explanatory diagrams for describing the impedance matching in the antenna apparatus 12, illustrating the Smith chart.

The impedance matching in the antenna apparatus 12 refers to a state in which the matching when the antenna linear element 18 and the transmission line 20 are viewed as the single load circuit, the impedance of this load circuit is matched with the impedance of the matching circuit 22. To be more specific, a normalized impedance of the matching circuit 22 has a complex conjugate relation with respect to the normalized impedance when the antenna linear element 18 and the transmission line 20 are viewed as the single load circuit. The normalized impedance refers to a value obtained by dividing the impedance by a characteristic impedance used in the transmission line 20 (for example, 50Ω).

The impedance matching on the Smith chart refers to a state in which the normalized impedance of the antenna linear element 18 is moved to a center point C of the Smith chart (see FIG. 2C) by functions of the transmission line 20 and the matching circuit 22. The center point C is a point where a value of a resistance component of the normalized impedance is 1, and a value of a reactance component is 0. By adjusting the matching circuit 22 so that the above-mentioned normalized impedance comes to the center point C, a largest current flows through the antenna linear element 18, and electric waves can be efficiently radiated.

Incidentally, the antenna linear element 18 is an element in which one end part is connected to the ground conductor 24 and grounded. For this reason, an ideal locus of the impedance obtained when the frequency of the signal supplied to the antenna linear element 18 is increased from 0 Hz is a locus like a circular arc-shaped curved line A shown in FIG. 2A. That is, this locus departs in the vicinity of the resistance component 0 at the frequency 0, moves clockwise along the curved line A which is a circle of a constant resistance (hereinafter, which will be referred to as constant resistance circle) in an area where the reactance component is positive in conjunction with the increase in the frequency, and reaches in the vicinity of a point B at the resonance frequency where the antenna linear element 18 has the impedance matching.

The transmission line 20 functions so as to move the above-mentioned locus of the impedance of the antenna linear element 18 in a D direction shown in FIG. 2A about the center point C. In the example shown in FIG. 2A, by the transmission line 20, the locus of the impedance in the previously set frequency band moves to a circular arc-shaped curved line E. At this time, the locus of the impedance of the curved line E after the movement is also substantially located on the constant resistance circle.

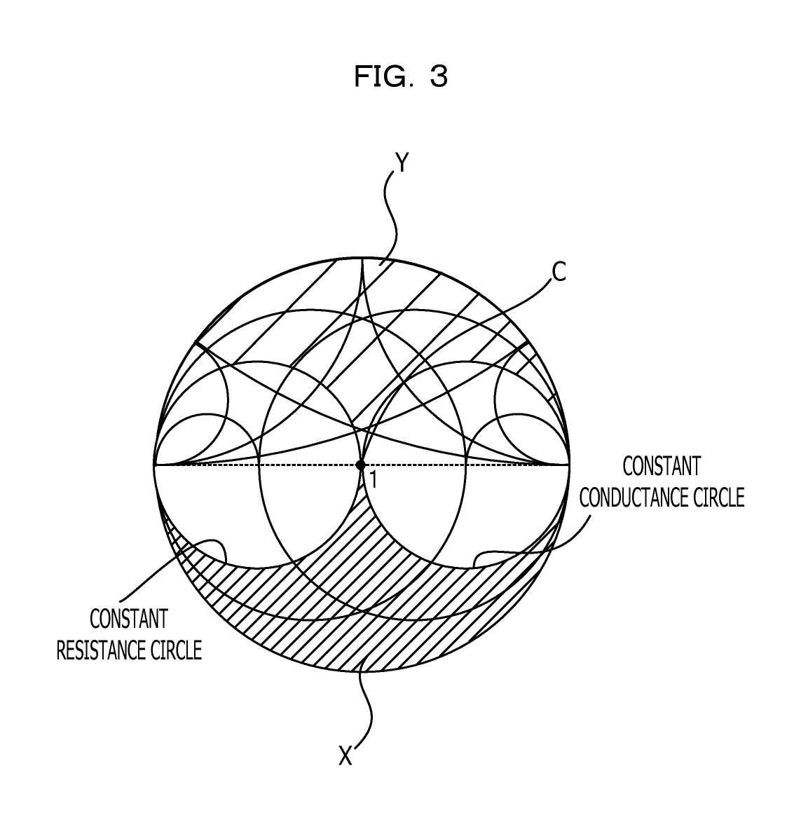

It should be noted that as the transmission line 20 functions as the distributed constant circuit, on the Smith chart, the impedance moves clockwise about the center point C in a circular arc manner. A moved distance at this time depends on the length of the transmission line 20. The length of the transmission line 20 is shorter than a length of ¼ of the wavelength corresponding to the use frequency. In general, at ¼ of the wavelength corresponding to the use frequency, on the Smith chart, the impedance moves half round about the center point C and moves round at ½ wavelength. Therefore, in order to move the impedance at the use frequency on the curved line A in an area where the reactance component on the Smith chart is positive to an area where the reactance component is negative, the locus of the impedance of the curved line A is moved in the D direction on the Smith chart to be larger than 0 degree and smaller than 180 degrees. With this configuration, the impedance at a time when the antenna linear element 18 and the transmission line 20 are viewed as the single load circuit is moved to an area where the matching can be realized by the matching circuit 22. The area where the matching can be realized is an shaded area X that is shaded by solid lines on the Smith chart shown in FIG. 3. This area will be described below.

Next, as shown in FIG. 2B, the first inductance element 22a of the matching circuit 22 converges the locus of the inductance of the curved line E to a point F. The point F is a point on the constant resistance circle where the locus of the impedance of the curved line E is substantially located, and further, is a point on the constant conductance circle passing through the center point C. The constant conductance circle passing through the center point C will be described below.

The first inductance element 22a has a function of moving the locus of the impedance along the constant resistance circle on the Smith chart. Therefore, by adjusting the inductance value L₁ of the first inductance element 22a, for example, the locus of the impedance of the curved line E substantially located on the constant resistance circle can be substantially converged at the point F at any frequency in the set frequency band. For example, as shown in FIG. 2A, the adjusting amount of the inductance for moving the impedance located at a point E₁ (frequency f₁ Hz) to the point F is set larger than the adjusting amount of the inductance for moving the impedance located at a point E₂ (frequency f₂ Hz) to the point F.

Next, the second inductance element 22b moves the impedance converged at the point F to the center point C. The second inductance element 22b is connected in parallel to the antenna linear element 18, the transmission line 20, and the first inductance element 22a. For this reason, as shown in FIG. 2C, the second inductance element 22b has a function of moving counterclockwise a point on the Smith chart along a circle of a constant conductance (hereinafter, which will be referred to as constant conductance circle) like a dotted line. Therefore, as shown in FIG. 2C, the second inductance element 22b can move the impedance located at the point F to the center point C. With this configuration, the impedance matching in the antenna apparatus 12 is realized.

Herein, in order for the point F to move to the center point C by the function of the second inductance element 22b (function of moving the impedance along the constant conductance circle), the point F is set on the constant conductance circle passing through the center point C. Therefore, the value of the reactance component at the point F is set so as to be located on the constant conductance circle passing through the center point C. In this manner, as the point F is the fixed point set in advance, the inductance value L₂ of the second inductance element 22b necessary for moving from the point F to the center point C can be set in advance.

The matching circuit 22 uses the first inductance element 22a connected in series to the antenna linear element 18 and the transmission line 20 and the second inductance element 22b connected in parallel to the antenna linear element 18 and the transmission line 20. For this reason, as the impedance at a time when the antenna linear element 18 and the transmission line 20 are viewed as the single load circuit is located at the shaded area X shown in FIG. 3, the impedance matching can be realized, that is, the impedance can be moved to the center point C. In other areas, the impedance matching cannot be realized by using the first inductance element 22a connected in series and the second inductance element 22b connected in parallel. The shaded area X shown in FIG. 3 will be referred to as impedance matching capable area in the following description.

It should be noted that the impedance matching capable area on the Smith chart shown in FIG. 3 is an area where the reactance component is negative and which is surrounded by the constant resistance circle where the normalized impedance passes through 1, the constant conductance circle where a normalized admittance (reciprocal of the normalized impedance) passes through 1, and the constant resistance circle where the resistance is 0.

The impedance matching capable area can be represented as follows when the antenna linear element 18 and the transmission line 20 are viewed in terms of the characteristic of the single load circuit. The impedance of the load circuit at the connection end of the transmission line 20 connected to the first inductance element 22a satisfies the following conditions (α) to (γ):

(α) The real part (resistance component) of the above-mentioned impedance of the load circuit is equal to or smaller than the characteristic impedance of the transmission line 20 at the use frequency used for the transmission or reception;

(β) At the use frequency used by the antenna apparatus 12 for the transmission or reception, the imaginary part (reactance component) of the impedance of the load circuit is smaller than 0; and

(γ) The real part (resistance component) of the admittance of the above-mentioned load circuit is equal to or smaller than a reciprocal of the characteristic impedance of the transmission line 20 at the above-mentioned use frequency.

That is, when the above-mentioned conditions (α) to (γ) are satisfied, through the adjustment of the matching circuit 22, the impedance matching at the use frequency can be realized.

In this manner, the antenna apparatus 12 can match the impedance at a time when the antenna linear element 18 functioning as the folded monopole antenna and the transmission line 20 are viewed as the single load circuit by using the first inductance element 22a connected in series and the second inductance element 22b connected in parallel of the matching circuit 22. At this time, by adjusting the inductance value L₁ of the first inductance element 22a (see FIG. 2B), the frequency for impedance matching can be changed. Therefore, by adjusting the inductance value L₁ of the first inductance element 22a, the impedance can be matched in accordance with the set use frequency. The impedance before the adjustment at this time is located on the right half of the Smith chart, and therefore the adjustment amount for the first inductance element 22a is relatively small.

Although the antenna apparatus 12 is an apparatus capable of changing the frequency for impedance matching, the first inductance element 22a of the matching circuit 22 is composed of an inductance fixed element, and the frequency for impedance matching may be fixed. In this case, with respect to the antenna apparatus 12 designed at the fixed frequency, by replacing the first inductance element 22a of the matching circuit 22 with an inductance element having a desired inductance, it is possible to easily fabricate an antenna apparatus having a different frequency for impedance matching.

In the antenna apparatus 12, for the impedance adjustment elements of the matching circuit 22, the inductance elements such as the first inductance element 22a and the second inductance element 22b are used, but as described above, instead of the first inductance element 22a and the second inductance element 22b, the first capacitance element and the second capacitance element can also be used. The impedance matching capable area in this case is an area line-symmetric to the shaded area X while an axis of the reactance component 0 is used as the line symmetry axis, that is, a shaded area Y. Then, a flow for moving the impedance shown in FIG. 2B and FIG. 2C to the center point C is similarly carried out in the shaded area Y.

### Second Embodiment

Next, a wireless communication apparatus of a second embodiment will be described.

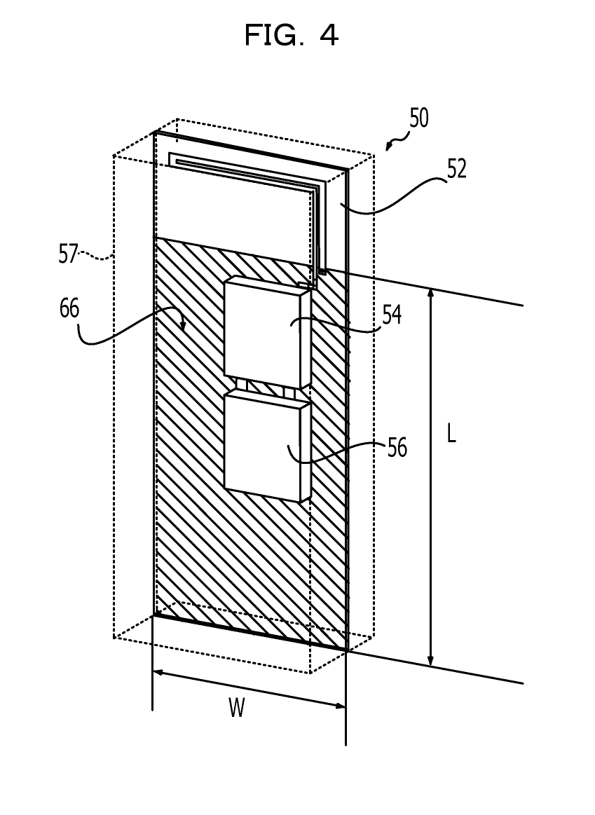

FIG. 4 is a schematic configuration diagram of a wireless communication apparatus 50 according to the second embodiment. The wireless communication apparatus 50 is provided with an antenna apparatus 52, a transmission/reception circuit 54, and a signal processing circuit 56.

The antenna apparatus 52 is an apparatus capable of changing the frequency for impedance matching.

The signal processing circuit 56 processes a signal to be transmitted or processes a received signal. The transmission/reception circuit 54 performs a modulation on the signal to be transmitted to generate a high frequency signal and feeds this high frequency signal to the antenna apparatus 52. Alternatively, the transmission/reception circuit 54 performs a demodulation on the received signal to be sent to the signal processing circuit 56.

The antenna apparatus 52, the transmission/reception circuit 54, and the signal processing circuit 56 are accommodated in a casing 57 shown in FIG. 4 (illustrated by a dotted line).

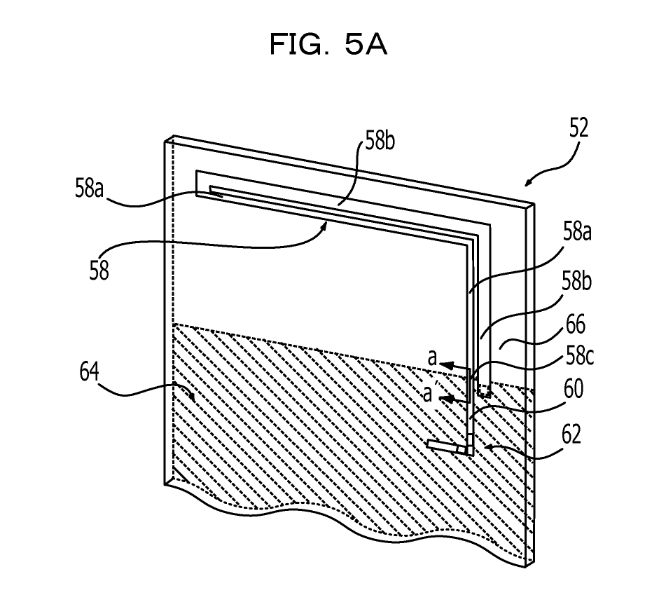

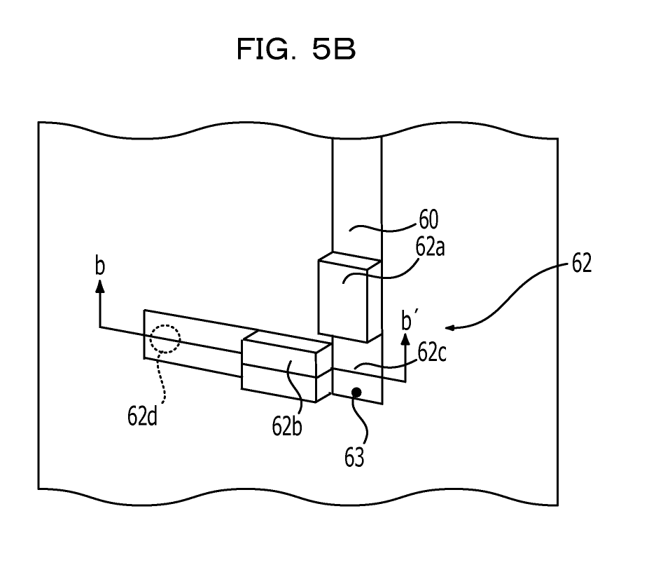

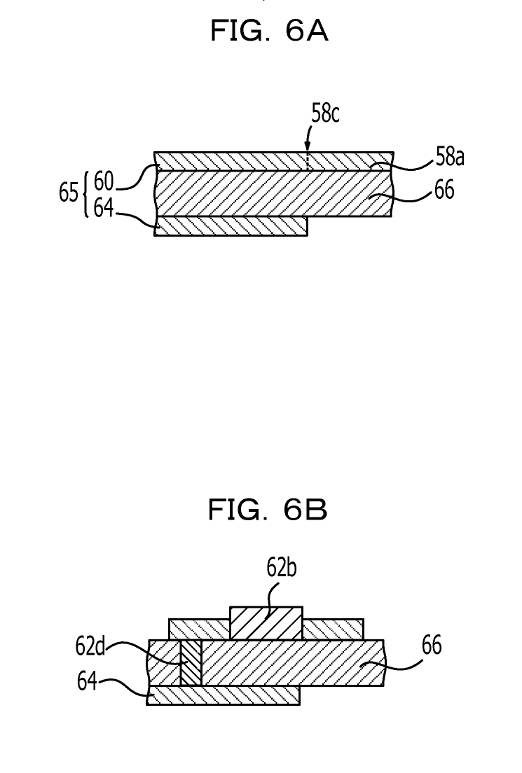

FIG. 5A and FIG. 5B show a schematic configuration of the antenna apparatus 52. FIG. 6A is an arrow sectional view as taken along the a-a′ line in FIG. 5A, and FIG. 6B is an arrow sectional view as taken along the b-b′ line in FIG. 5B. In FIG. 5A and FIG. 5B, illustrations of the transmission/reception circuit 54 and the signal processing circuit 56 are omitted.

The antenna apparatus 52 has an antenna linear element 58, a transmission line 60, a matching circuit 62, a ground conductor 64, and a dielectric substrate 66. On the dielectric substrate 66, the transmission/reception circuit 54 and the signal processing circuit 56 are mounted, and the dielectric substrate 66 is accommodated within the casing 57.

On one surface of the dielectric substrate 66 (hereinafter, which will be referred to as front surface), the antenna linear element 58, the transmission line 60, and the matching circuit 62 are provided, and on a surface opposite to this surface (hereinafter, which will be referred to as rear surface), the ground conductor 64 is provided.

The antenna linear element 58 is a folded monopole antenna having a shape in which the extending direction of one linear conductor provided on the surface of the dielectric substrate 66 is inverted in mid-course to be folded into a U-letter shape. That is, the antenna linear element 58 has an outward linear element 58a and an inward linear element 58b extending in parallel to each other, and the outward linear element 58a and the inward linear element 58b are connected to each other at mutual end of the linear elements.

Furthermore, the outward linear element 58a and the inward linear element 58b of the antenna linear element 58 both form an L-letter shape as the extending direction is bent in mid-course by 90 degrees while mutually keeping the parallel relation. The line width of the inward linear element 58b is wider than the line width of the outward linear element 58a. By setting the line width of the inward linear element 58b to be wider than the line width of the outward linear element 58a, as will be described below, on the Smith chart, a valley where the real part of the impedance is changed can be suppressed. The end of the inward linear element 58b of the antenna linear element 58 is connected to the ground conductor 64 provided on the rear surface via a via conductor.

The transmission line 60 has the same line width as the outward linear element 58a and is connected to an end 58c of the outward linear element 58a. As shown in FIG. 6A, the transmission line 60 forms a microstrip line 65 functioning as a distributed constant circuit together with the ground conductor 64 provided on the rear surface of the dielectric substrate 66. The transmission line 60 is connected to the outward linear element 58a and functions as the distributed constant circuit that connects the matching circuit 62 with the outward linear element 58a. It should be noted that the characteristic impedance of the transmission line 60 is set, for example, as 50Ω.

The matching circuit 62 is provided with two inductance elements. FIG. 5B shows a configuration of the matching circuit 62. The matching circuit 62 is provided with a first inductance element 62a and a second inductance element 62b. The first inductance element 62a is connected in series to the transmission line 60 at the end of the transmission line 60. One end of the second inductance element 62b is connected to a conductor 62c extending from the first inductance element 62a and an end on the opposite side to this end is connected to the ground conductor 64 provided on the rear surface via a via conductor 62d and grounded as shown in FIG. 6B. In other words, the second inductance element 62b is connected in parallel to the first inductance element 62a, the transmission line 60, and the antenna linear element 58. It should be noted that the connection between the transmission/reception circuit 54 and the matching circuit 62 is established at a point 63 shown in FIG. 5B, and the point 63 functions as a feeding point.

According to the second embodiment, in order to change the reactance component of the impedance of the antenna apparatus 52, for the first inductance element 62a, the inductance variable element is used, but other than the inductance variable element, variable capacitors may also be used by being connected in series. The variable capacitor can change the reactance component of the impedance of the antenna apparatus 52 through the adjustment on the capacitance. Therefore, in a case where the variable capacitor is used, the first inductance element 62a may use an inductance fixed element.

The ground conductor 64 is made of a conductive metallic film provided on the rear surface of the dielectric substrate 66 while being grounded. For the conductive film for the ground conductor 64, a metal such as copper, silver, gold, or platinum is used.

As shown in FIG. 6A, the ground conductor 64 is not provided in an area on the rear surface corresponding to the area where the antenna linear element 58 is provided. The ground conductor 64 is provided in an area on the rear surface corresponding to the area where the transmission line 60, the matching circuit 62, the transmission/reception circuit 54, and the signal processing circuit 56 are provided from a position where the outward linear element 58a of the antenna linear element 58 is connected to the transmission line 60.

The thus configured antenna apparatus 52 can realize the impedance matching shown in FIG. 2A to FIG. 2C and further can change the frequency for impedance matching similarly as in the first embodiment.

### Example of the Second Embodiment

The impedance of the load circuit at a time when the antenna linear element 58 and the transmission line 60 are viewed as the single load circuit was calculated by using electromagnetic field analysis software. For the dimensions and characteristics of the antenna apparatus 52, values shown in the following Table 1 were used.

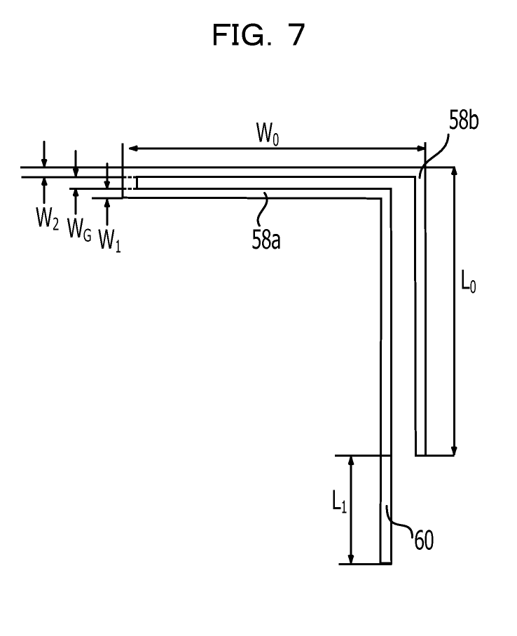

Furthermore, by using the calculation result of the impedance, a frequency dependency of a reflection coefficient of the antenna apparatus 52 (S₁₁ parameter in one port system) is obtained. FIG. 4 and FIG. 7 show dimensional locations of the respective parts of the antenna apparatus 52. According to the present embodiment, 600 MHz to 1 GHz are set as the use frequency.

TABLE 1

| | | Dimensions, |
|---|---|---|
| Components | Dimensions, characteristic names | characteristics |
| Dielectric | Relative dielectric constant ∈ᵣ | ∈ᵣ = 4.0 |
| substrate | Dielectric loss tangent tanδ | tanδ = 0.01 |
| | Thickness | 0.4 mm |
| Ground | Thickness | 35 μm |
| conductor | Width W (see FIG. 4) | W = 50 mm |
| (copper) | Length L (see FIG. 4) | L = 100 mm |
| Antenna linear | Line width W₁ (see FIG. 7) | W₁ = 1 mm |
| element | Line width W₂ (see FIG. 7) | W₂ = 2 mm |
| | Gap W_{G} (see FIG. 7) | W_{G} = 0.5 mm |
| | Width W₀ (see FIG. 7) | W₀ = 48 mm |
| | Length L₀ (see FIG. 7) | L₀ = 20 mm |
| Transmission | Length L₁ (see FIG. 7) | L₁ = 15 mm |
| line | Line width | 1 mm |
| Matching circuit | Inductance of first inductance | L₁ = 5 to 60 nH |
| | element | (variable) |
| | Inductance of second inductance | L₂ = 8 nH |
| | element | |

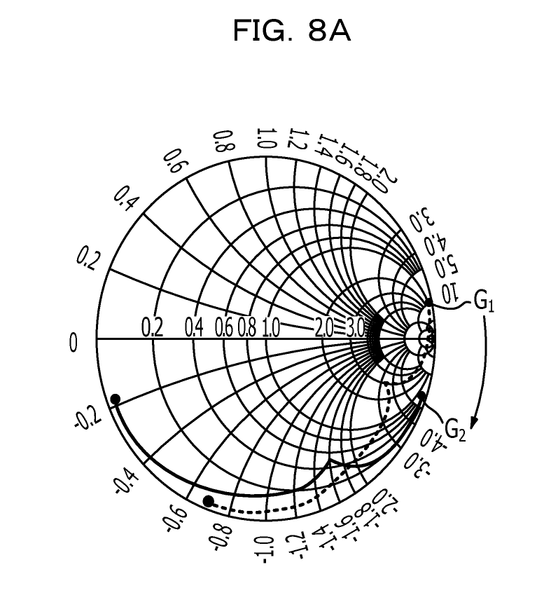

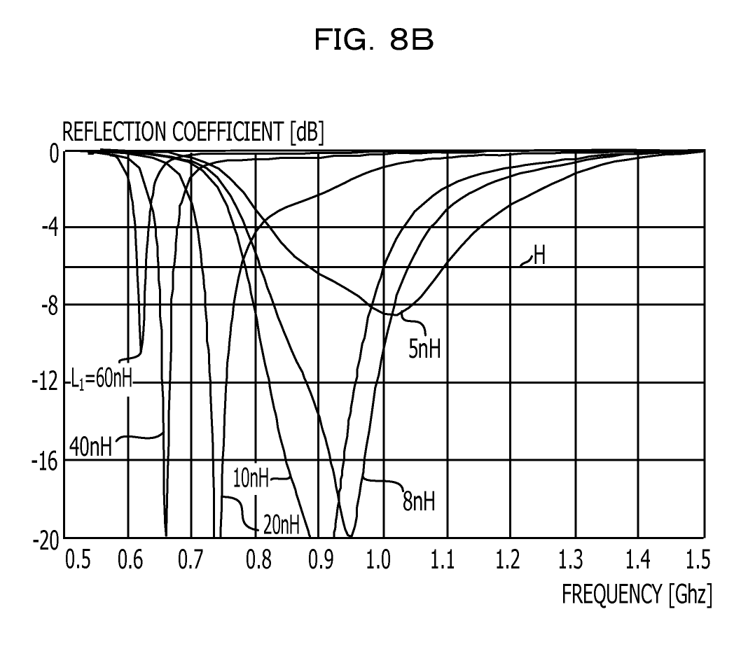

FIG. 8A shows a simulation result of the impedance at a time when the antenna linear element 58 and the transmission line 60 using the values shown in Table 1 are viewed as the single load circuit in the Smith chart. FIG. 8A shows a locus of the impedance by a solid line (Example) within a frequency range of 600 MHz to 1.5 GHz. A locus of the impedance represented by a dotted line in FIG. 8A is an example (Comparison Example) at a time when the transmission line 60 is not provided, and other configurations and dimensions are the same conditions.

As will be understood from the Smith chart shown in FIG. 8A, the locus of the impedance according to Example which is represented by the solid line is located in the impedance matching capable area by the matching circuit 62 (shaded area shown in FIG. 3) in the range of the frequency 600 MHz to 1.5 GHz. On the other hand, a part of the locus of the impedance according to Comparison Example which is represented by the dotted line is not located in the impedance matching capable area. A point G₁ in FIG. 8A indicates a location of the impedance at the frequency 600 MHz according to Comparison Example. This point G₁ is not located in the impedance matching capable area shown in FIG. 3. However, the point G₁ is moved to a point G₂ according to Example and located in the impedance matching capable area. In this manner, it is understood that by connecting the antenna linear element 58 with the transmission line 60, the impedance where the impedance matching can be realized in the matching circuit 62 is provided.

Therefore, when the antenna linear element 58 and the transmission line 60 according to Example are viewed as the single load circuit, this load circuit satisfies the above-mentioned conditions (α) to (γ) at least in the frequency bands of 600 MHz to 1.5 GHz.

FIG. 8B shows a frequency dependency of the reflection coefficient which is calculated by using the calculation result of the impedance (S₁₁ parameter) shown in FIG. 8A. At that time, the inductance value L₁ of the first inductance element 62a is changed between a range of 5 nH to 60 nH. It is indicated that in the frequency dependency of the reflection coefficient, when a bottom is formed where the reflection coefficient drastically falls, the impedance matching is realized, and the power is efficiently fed to the antenna apparatus 52. According to the frequency dependency of FIG. 8B, it is understood that as the adjusting amount of the inductance of the first inductance element 62a is smaller, the impedance matching is realized at a higher frequency. In other words, it is understood that as the use frequency is higher, the value of the inductance of the first inductance element 62a may be set smaller.

Herein, a straight line H in FIG. 8B represents a position where the reflection coefficient is −6 dB. It is represented that in an area where the reflection coefficient is below the straight line H, the reflection coefficient is decreased, and a standing wave ratio (SWR) is smaller than 3. When the SWR is smaller than 3, the antenna apparatus can be practically used. Therefore, on the basis of frequency the characteristic of the reflection coefficient shown in FIG. 8B, at the frequency of 600 MHz to 1 GHz, it is possible to practically use the antenna apparatus 52.

As described above, while the inductance of the second inductance element 62b is fixed, the impedance matching is realized by changing the inductance of the first inductance element 62a, and it is possible to change the frequency which the antenna apparatus 52 can practically use.

It should be noted that in a case where the first inductance element 62a is composed of a fixed inductance element, by providing one variable capacitor, the inductance can also be changed.

In this manner, the antenna apparatus 52 can match the impedance at a time when the antenna linear element 58 functioning as the folded monopole antenna and the transmission line 60 are viewed as the single load circuit by using the first inductance element 62a connected in series to the above-mentioned load circuit and the second inductance element 62b connected in parallel to the above-mentioned load circuit of the matching circuit 62. At this time, by adjusting the inductance value L₁ of the first inductance element 62a, it is possible to freely adjust the frequency where the impedance is matched. Therefore, by adjusting the inductance value L₁ of the first inductance element 62a, the impedance can be matched at the set use frequency.

The microstrip line has a simple configuration as a transmission line and is therefore high in practicality.

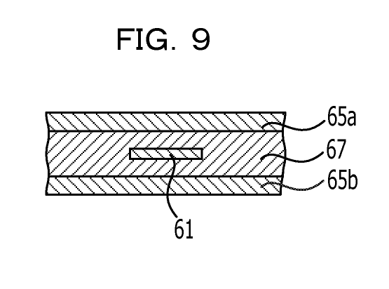

Instead of the microstrip line, a strip line shown in FIG. 9 may be used. The strip line can reduce the transmission loss as a transmission line 61 is provided in an inner part of a dielectric substrate 67, and the transmission line 61 is sandwiched by two ground conductors 65a and 65b provided on the surfaces on both sides of the dielectric substrate 67.

### Third Embodiment

Next, a third embodiment will be described.

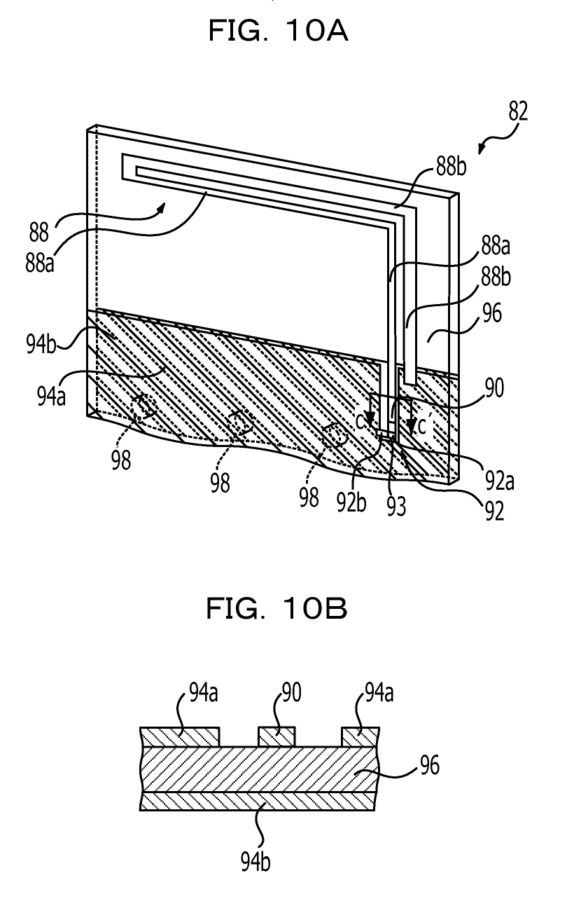

FIG. 10A shows a schematic configuration of an antenna apparatus 82 according to the third embodiment. The antenna apparatus 82 is connected to a transmission/reception circuit which is not shown in the drawing, and the transmission/reception circuit is connected to a signal processing circuit which is not shown in the drawing.

The antenna apparatus 82 is an apparatus capable of changing the frequency for impedance matching.

FIG. 10B is an arrow sectional view as taken along the c-c′ line in FIG. 10A.

The antenna apparatus 82 has an antenna linear element 88, a transmission line 90, a matching circuit 92, ground conductors 94a and 94b, and a dielectric substrate 96. The transmission/reception circuit, and the signal processing circuit which are not shown in the drawing are mounted on the dielectric substrate 96.

On one surface of the dielectric substrate 96 (hereinafter, which will be referred to as front surface), the antenna linear element 88, the transmission line 90, the matching circuit 92, and the ground conductor 94a are provided, and on a surface opposite to this surface (hereinafter, which will be referred to as rear surface), the ground conductor 94b is provided.

The antenna linear element 88 is a folded monopole antenna which has a similar shape to that of the antenna linear element 58 according to the second embodiment and is provided with an outward linear element 88a and an inward linear element 88b. An end of the inward linear element 88b of the antenna linear element 88 is connected to the ground conductor 94a provided on a front surface of the dielectric substrate 96.

A detailed content of the antenna linear element 88 is similar to that of the antenna linear element 58 according to the second embodiment, and a detailed description of the antenna linear element 88 will be omitted.

The transmission line 90 has the same line width as the outward linear element 88a of the antenna linear element 88 and is connected to an end of the outward linear element 88a. The transmission line 90 forms the coplanar line together with the ground conductor 94a. That is, on both the sides perpendicular to the extending direction of the transmission line 90, as shown in FIG. 10B, the ground conductors 94a are provided so as to be away from each other at a certain distance. The ground conductor 94a has a notch part notched at a certain width along an area where the transmission line 90 is located.

The matching circuit 92 is provided with two inductance elements. The matching circuit 92 is provided with a first inductance element 92a and a second inductance element 92b which are similar to the first inductance element 62a and the second inductance element 62b according to the second embodiment.

Similarly as in the first inductance element 62a, the first inductance element 92a is connected in series to the transmission line 90 at an end of the transmission line 90. Also, similarly as in the second inductance element 62b, one end of the second inductance element 92b is connected to a conductor extending from the first inductance element 92a, and the other end is connected to the ground conductor 94a of the dielectric substrate 96 and grounded. That is, similarly as in the second inductance element 62b, the second inductance element 92b is connected in parallel to the first inductance element 92a, the transmission line 90, and the antenna linear element 88.

It should be noted that a part which extends from the first inductance element 92a and is connected to the second inductance element 92b is connected to the transmission/reception circuit which is not shown in the drawing. That is, a point 93 in FIG. 10A functions as a feeding point.

A detailed content of the matching circuit 92 is similar to that of the matching circuit 62 according to the second embodiment, and therefore a detailed description on the detail of the matching circuit 92 will be omitted.

The ground conductors 94a and 94b are made of a conductive metallic film such as copper, silver, gold, or platinum and grounded.

As shown in FIG. 10A, the ground conductors 94a and 94b are not provided on the area of the front surface where the antenna linear element 88 is provided and the area of the rear surface corresponding to this area. The ground conductors 94a and 94b extend from the position where the outward linear element 88a of the antenna linear element 88 is connected to the transmission line 90 to the area of the front surface where the matching circuit 92 is provided (except the notch part for providing the transmission line 90) and the area of the rear surface corresponding to this area. Also, in order to avoid a situation in which a voltage distribution is locally generated between the ground conductor 94a and the ground conductor 94b to generate a current density, the ground conductor 94a and the ground conductor 94b are mutually connected via conductors 98 provided at a certain gap which penetrate through the dielectric substrate 96.

The above-mentioned antenna apparatus 82 can realize the impedance matching shown in FIG. 2A to FIG. 2c similarly as in the first embodiment and further can change the frequency for impedance matching.

### Example of the Third Embodiment

The impedance of the load circuit at a time when the antenna linear element 88 and the transmission line 90 are viewed as the single load circuit was calculated by using the electromagnetic field analysis software. For the dimensions and characteristics of the antenna apparatus 82, values shown in the following Table 2 were used.

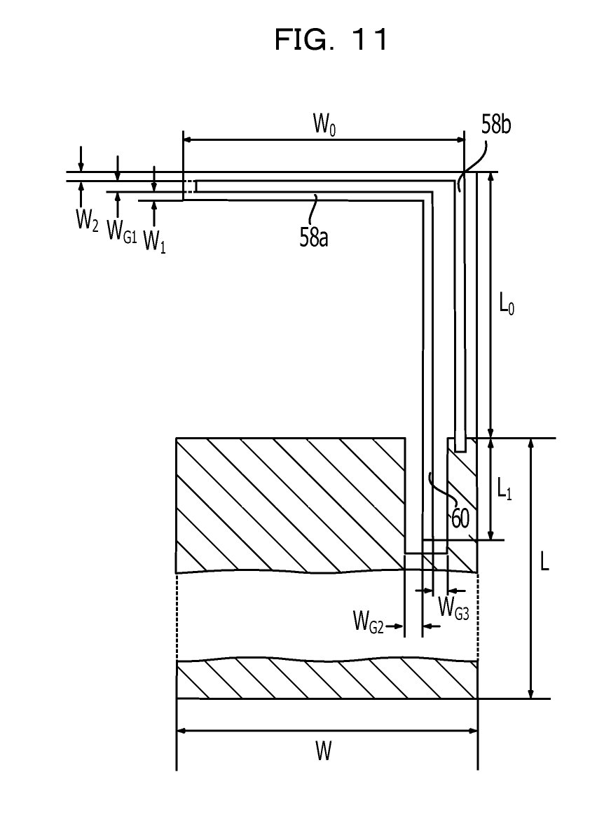

Furthermore, by using this calculation result, the frequency dependency of the reflection coefficient of the antenna apparatus 82 (S₁₁ parameter in one port system) is obtained. It should be noted that according to Example, 600 MHz to 1 GHz are set as the use frequency. FIG. 11 shows dimension positions for respective parts in the antenna apparatus 82.

TABLE 2

| | | Dimensions, |
|---|---|---|
| Components | Dimensions, characteristic names | characteristics |
| Dielectric | Relative dielectric constant ∈ᵣ | ∈ᵣ = 4.0 |
| substrate | Dielectric loss tangent tanδ | tanδ = 0.01 |
| | Thickness | 0.4 mm |
| Ground | Thickness | 35 μm |
| conductor | Width W (see FIG. 11) | W = 50 mm |
| (copper) | Length L (see FIG. 11) | L = 100 mm |
| Antenna linear | Line width W₁ (see FIG. 11) | W₁ = 1 mm |
| element | Line width W₂ (see FIG. 11) | W₂ = 2 mm |
| | Gap W_{G1} (see FIG. 11) | W_{G1} = 0.5 mm |
| | Width W₀ (see FIG. 11) | W₀ = 48 mm |
| | Length L₀ (see FIG. 11) | L₀ = 20 mm |
| Transmission | Length L₁ (see FIG. 11) | L₁ = 15 mm |
| line | Line width | 1 mm |
| | Gap W_{G2} (see FIG. 11) | W_{G2} = 1 mm |
| | Gap W_{G3} (see FIG. 11) | W_{G3} = 0.5 mm |
| Matching circuit | Inductance of first inductance | L₁ = 5 to 50 nH |
| | element | (variable) |
| | Inductance of second inductance | L₂ = 5 nH |
| | element | |

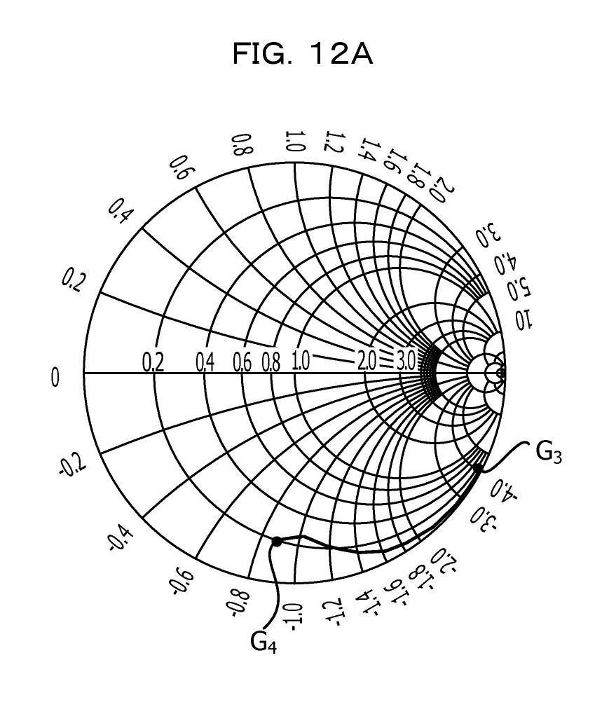

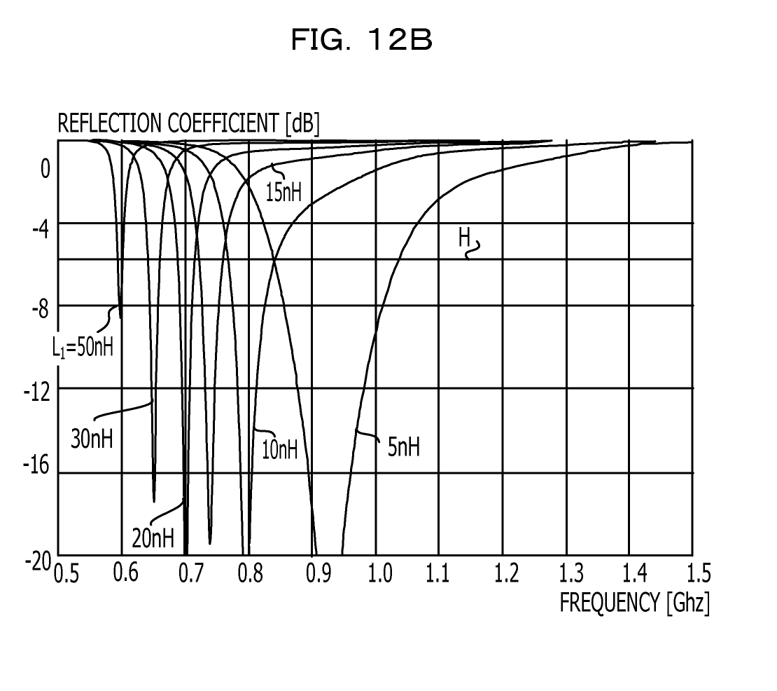

FIG. 12A shows a simulation result of the impedance at a time when the antenna linear element 88 and the transmission line 90 using the values shown in Table 2 are viewed as the single load circuit in the Smith chart. FIG. 12A shows a locus of the impedance within a frequency range of 600 MHz to 1.0 GHz by a solid line.

As will be understood from the Smith chart shown in FIG. 12A, the locus of the impedance represented by the solid line is located within the impedance matching capable area by the matching circuit 92 (shaded area shown in FIG. 3) within the frequency range of 600 MHz to 1.0 GHz. A point G₃ and a point G₄ in FIG. 12A respectively indicate impedances at the frequency 600 MHz and the frequency 1 GHz. In this manner, it is understood that by connecting the antenna linear element 88 with the transmission line 90, the impedance where the impedance matching can be realized in the matching circuit 92 is provided.

Therefore, when the antenna linear element 88 and the transmission line 90 constitute the load circuit according to Example are viewed as the single load circuit, this load circuit satisfies the above-mentioned conditions (α) to (γ) in the frequency band of 600 MHz to 1 GHz.

FIG. 12B shows a frequency dependency of the reflection coefficient which is calculated by using the calculation result of the impedance shown in FIG. 12A. At that time, the inductance value L₁ of the first inductance element 92a is changed between a range of 5 nH to 50 nH. According to the result shown in FIG. 12B, similarly as in the result shown in FIG. 8B, it is understood that as the adjusting amount of the inductance of the first inductance element 92a is smaller, the impedance matching is realized at a higher frequency.

Herein, a straight line H in FIG. 12B represents a position where the reflection coefficient is −6 dB. It is represented that in an area where the reflection coefficient is below the straight line H, the reflection coefficient is decreased, and the standing wave ratio (SWR) is smaller than 3. When the SWR is smaller than 3, the antenna apparatus can be practically used. Therefore, on the basis of the frequency characteristic of the reflection coefficient shown in FIG. 12B, at the frequency of 600 MHz to 1 GHz, the antenna apparatus 82 can be practically used.

In this manner, the antenna apparatus 82 can match the impedance at a time when the antenna linear element 88 functioning as the folded monopole antenna and the transmission line 90 are viewed as the load circuit by using the first inductance element 92a connected in series to the load circuit and the second inductance element 92b connected in parallel to the load circuit. At this time, by adjusting the inductance value L₁ of the first inductance element 92a, it is possible to change the frequency for impedance matching. Therefore, by adjusting the inductance value L₁ of the first inductance element 92a, the impedance can be matched at the set use frequency.

The coplanar line uses the dielectric substrate 96 in which the ground conductor 94a is provided on the front surface and also the ground conductor 94b is provided on the rear surface, but such a substrate is normally used as a mount circuit substrate in a wireless communication apparatus. Therefore, by using the mount circuit substrate, without troubles, the antenna apparatus 82 can be fabricated. Also, as the ground conductor 94a is provided on the front surface of the surface of the dielectric substrate 96, it is not necessary to provide a via conductor for the ground of the second inductance element 92b and the ground of the inward linear element 88b, and the configuration is simplified.

Line Width of the Antenna Linear Element

The shape of the antenna linear element functioning as the folded monopole antenna used in the first to third embodiments has been investigated. Subsequently, the description will be given while representing the antenna linear element 58.

To be more specific, a way in which the impedance at a time when the antenna linear element 58 and the transmission line 60 are viewed as the single load circuit changes in accordance with the change in the line width of the inward linear element 58b (line width W₂) of the antenna linear element 58 is calculated by using the electromagnetic field analysis software. The specific dimensions and characteristics of the antenna apparatus 52 use the values of Table 1 according to the second embodiment. The line width W₁ of the outward linear element 58a is fixed, and only the line width W₂ of the inward linear element 58b is changed between a range of 0.5 mm to 6.0 mm.

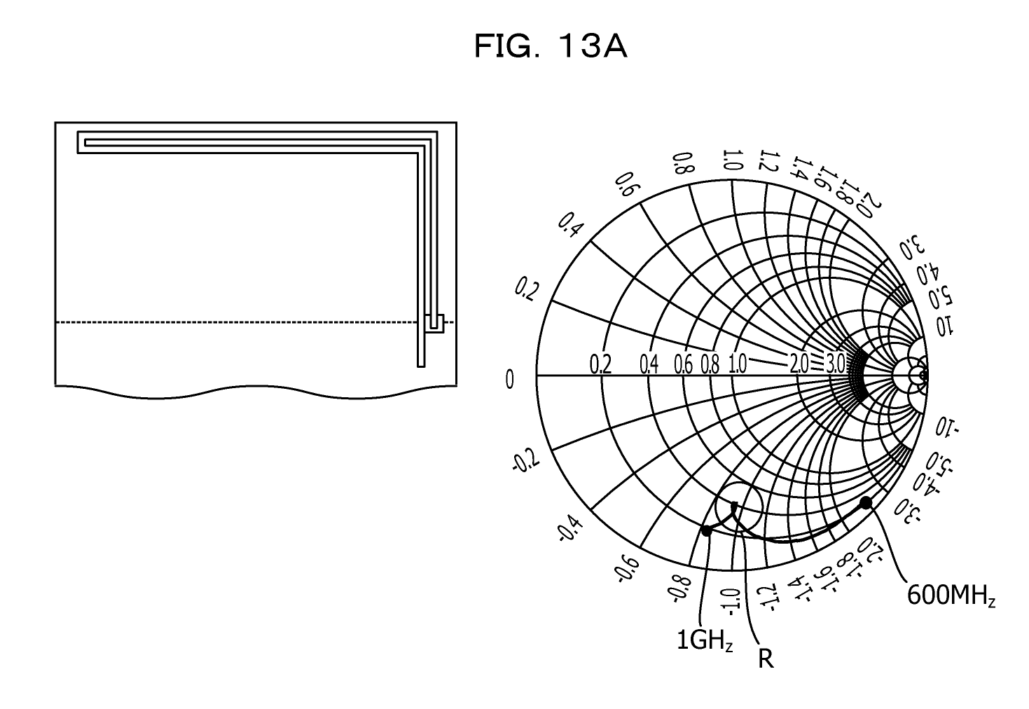

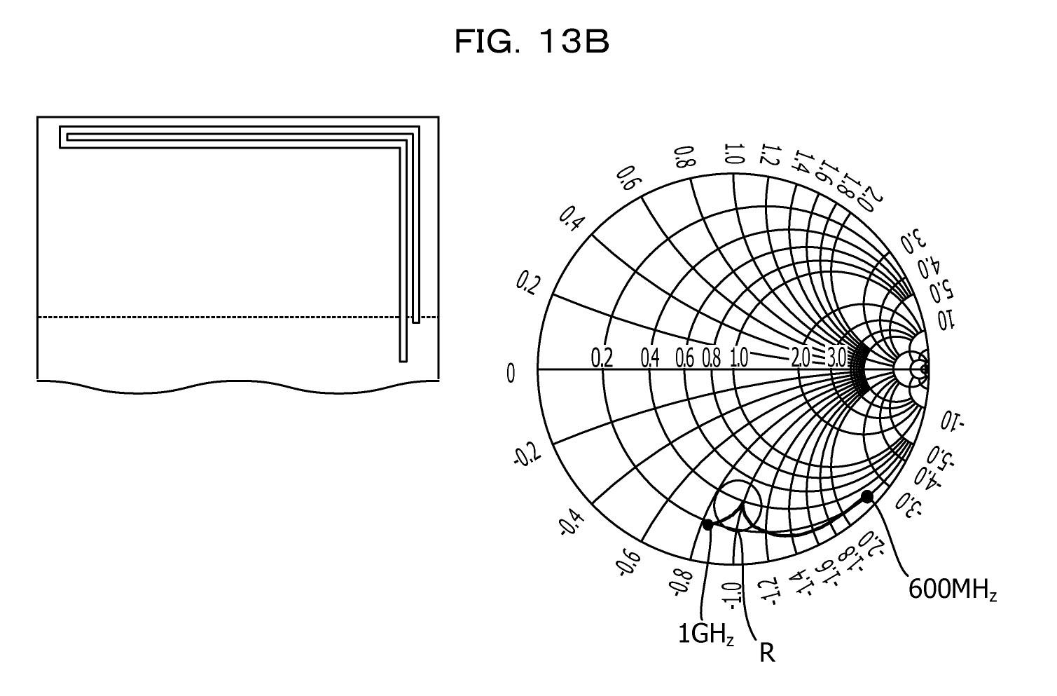

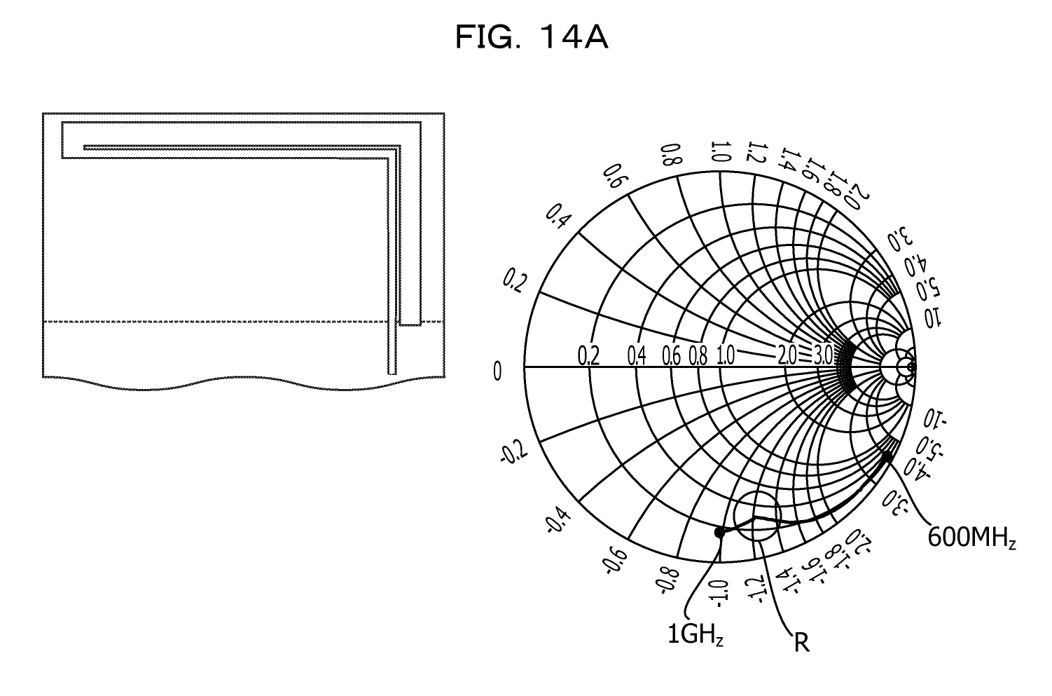

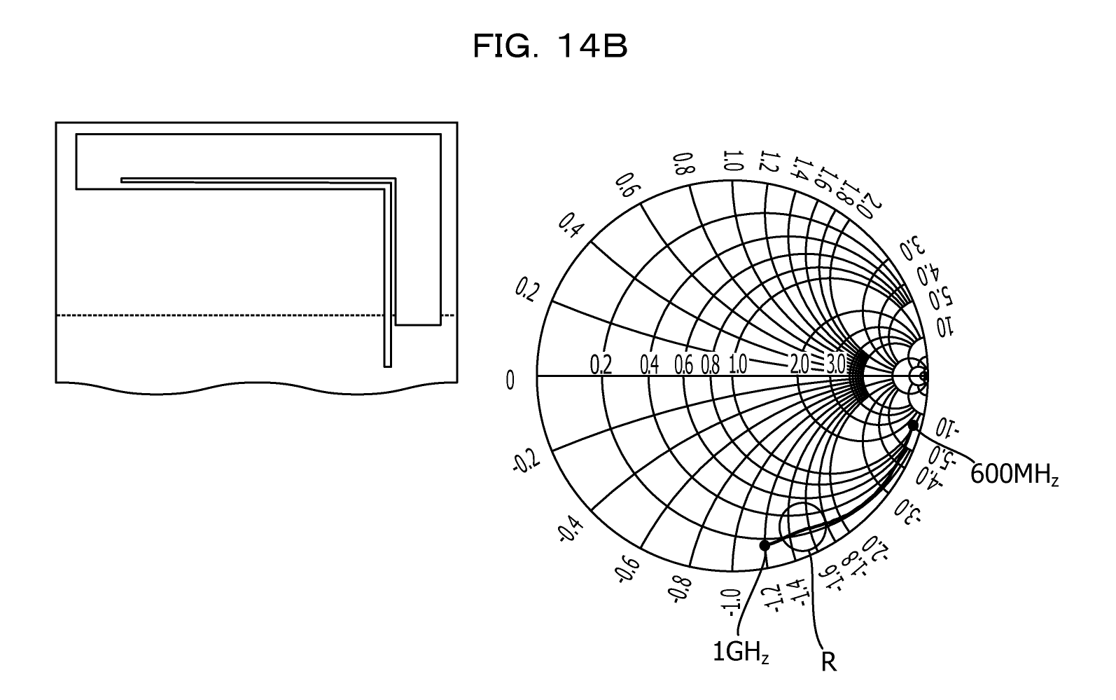

FIG. 13A, FIG. 13B, FIG. 14A, and FIG. 14B respectively show the shape of the antenna linear element 58 while the line width W₁ is fixed at 1.0 mm and the line width W₂ is changed between the range of 0.5 mm to 6.0 mm and the locus of the impedance at the frequency of 600 MHz to 1 GHz on the Smith chart.

As will be understood from these loci of the impedance, as the line width W₂ is wider than the line width W₁, as illustrated in an area R in the Smith chart, a valley where the real part of the impedance is changed becomes smaller. Therefore, as this valley becomes smaller, it is possible to suppress the increase in the ratio of the SWR at a time when the impedance matching is carried out at the frequency in the vicinity of the valley. Furthermore, as the above-mentioned valley is smaller, the radiation resistance of the antenna linear element 58 can be maintained constant. Therefore, the line width W₂ of the antenna linear element 58 is preferably wider than the line width W₁. Similarly, also according to the third embodiment using the coplanar line, the line width W₂ of the antenna linear element 88 is preferably wider than the line width W₁.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

1. An antenna apparatus provided with a matching circuit, the antenna apparatus comprising:
an antenna linear element including a linear conductor provided with a first end and a second end;
a ground conductor connected to the linear conductor at the second end;
a transmission line connected to the linear conductor at the first end; and
a matching circuit including a first impedance adjustment element connected to the transmission line at an end on an opposite side to the end of the transmission line connected to the linear conductor and a second impedance adjustment element which is connected to the first impedance adjustment element at an end on an opposite side to the end of the first impedance adjustment element connected to the transmission line and an end of which on an opposite side to the end connected to the first impedance adjustment element is grounded, a connection part between the first impedance adjustment element and the second impedance adjustment element receiving a power feed.

2. The antenna apparatus according to claim 1, wherein:
a range of a use frequency used for transmission or reception in the antenna apparatus is determined;
an electric length of the antenna linear element is equal to a length of ¼ of a wavelength corresponding to a predetermined frequency within the range of the use frequency;
when the antenna linear element and the transmission line are viewed as a single load circuit, within the range of the use frequency, a real part of an impedance of the single load circuit is equal to or smaller than a characteristic impedance of the transmission line, and also an imaginary part of the impedance of the single load circuit is smaller than 0; and
within the range of the use frequency, a real part of an admittance of the single load circuit is equal to or smaller than a reciprocal of the characteristic impedance of the transmission line.

3. The antenna apparatus according to claim 1, wherein:
a range of a use frequency used for transmission or reception in the antenna apparatus is determined;
the transmission line is provided in such a manner that an impedance of the antenna linear element moves to a predetermined area on a Smith chart within the range of the use frequency;
the first impedance adjustment element adjusts the moved impedance to have a predetermined impedance value within a predetermined range; and
the second impedance adjustment element adjusts the adjusted impedance to a center on the Smith chart.

4. The antenna apparatus according to claim 1, wherein an extending direction of the linear conductor is inverted in mid-course, and the linear conductor has an outward linear element extending from the first end to an inverted position of the extending direction and an inward linear element extending from the inverted position to the second end while being in parallel to the outward linear element.

5. The antenna apparatus according to claim 4, wherein a line width of the inward linear element of the antenna linear element is wider than a line width of the outward linear element.

6. The antenna apparatus according to claim 1, wherein a line length of the transmission line is shorter than ¼ of a wavelength corresponding to a use frequency used for transmission or reception in the antenna apparatus.

7. The antenna apparatus according to claim 1, wherein the first impedance adjustment element and the second impedance adjustment element are inductance elements.

8. The antenna apparatus according to claim 7, wherein the matching circuit includes a variable capacitor connected in series to the first impedance adjustment element.

9. The antenna apparatus according to claim 8, wherein the variable capacitor is one of a varactor diode and an MEMS variable capacitor fabricated through MEMS (Micro Electro Mechanical Systems).

10. The antenna apparatus according to claim 1, wherein:
the ground conductor, the transmission line, and the antenna linear element are provided on a dielectric substrate;
the ground conductor is provided on a surface on an opposite side to a surface of the dielectric substrate where the transmission line is provided;
the transmission line forms a microstrip line together with the ground conductor; and
the second end of the antenna linear element is connected to the ground conductor via a via conductor penetrating through the dielectric substrate.

11. The antenna apparatus according to claim 1, wherein:
the ground conductor, the transmission line, and the antenna linear element are provided on a dielectric substrate;
the ground conductor is provided on a same surface as a surface of the dielectric substrate where the transmission line is provided; and
the transmission line forms a coplanar line together with the ground conductor.

12. The antenna apparatus according to claim 1, wherein:
the ground conductor, the transmission line, and the antenna linear element are provided on a dielectric substrate;
the ground conductor is provided on both surfaces of the dielectric substrate; and
the transmission line is a strip line provided in an inner part of the dielectric substrate.

13. A wireless communication apparatus comprising:
the antenna apparatus as claimed in claim 1;
a transmission/reception circuit connected to the antenna apparatus; and
a signal processing apparatus connected to the transmission/reception circuit and configured to process a signal to be transmitted or a received signal.
